(19) United States
(12) Patent Application Publication
(10) Pub. No.: US 2006/0010268 A1
(43) Pub. Date: Jan. 12, 2006

(54) Display device graphics interface

(75) Inventor: Lance Garland, Wilsonville, OR (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: InFocus Corporation, Wilsonville, OR (US)

(21) Appl. No.: 11/069,200

(22) Filed: Feb. 28, 2005

Related U.S. Application Data
(60) Provisional application No. 60/586,188, filed on Jul. 7, 2004.

(51) Int. Cl. G06F 13/12

(52) U.S. Cl. 710/72

(57) ABSTRACT

A graphics interface included in a first graphics display device. The graphics interface includes a first graphics port that, in operation, functions as a graphics input port receiving graphics information to be displayed by the first display device from a graphics source. The graphics interface further includes a second graphics port that selectively operates as one of an alternative graphics input port to the first graphics port and a graphics output port. The second graphics port, when operating as a graphics output port, communicates the graphics information received at the first graphics port to a second display device.

### CROSS REFERENCE TO RELATED APPLICATIONS

This application claims priority benefits under 35 U.S.C. § 119(e) to U.S. Provisional Patent Application No. 60/586,188, filed on Jul. 7, 2004. The entire disclosure of U.S. Provisional Patent Application No. 60/586,188 is incorporated by reference herein in its entirety.

### FIELD OF THE INVENTION

This invention is related to the field of display devices, such as computer display devices and entertainment display devices. More particularly, the invention is related to an improved graphics interface for use in such display devices.

### BACKGROUND

1. Overview

Display technology (e.g., for use in computer and entertainment display devices) continues to advance, as generally is the case with consumer and business electronics. Display devices (such as digital display projectors, flat panel displays, plasma displays, cathode-ray-tube (CRT) displays, etc.) continue to improve in the quality and resolution of the images they display. Along with these improvements in display quality and resolution, the number of features and flexibility of use for such devices has also increased. Further, as the technologies included in such devices improve, the physical size and mass of such display devices is often reduced. This reduction in size and weight is desirable from the stand point of consumers, as such devices use less space and are easier to transport (e.g., use as portable devices).

However, increasing the features and flexibility of use of a particular display device may, at times, run counter to the desire to reduce the physical size and weight of such display devices. That is, reducing the size of a display device may limit the ability to provide certain functional capabilities or, likewise, providing certain functional capabilities may limit the ability to reduce the size and weight of a display device. For example, in digital projection systems, it is desirable to provide a graphics interface including different graphics input and output ports (e.g., for communicating electronic graphics information into and, in certain applications, out of the projection system). Such an interface allows for the projection system to be employed in a variety of configurations. It is also desirable to make such display projectors as physically compact, and with as low a mass as possible, so as to allow them to be easily transported.

Specifically, with respect to allowing the projection system to be employed in a variety of configurations, in one application it may be desirable to communicate graphics display information to such a projection system using a graphics input port in accordance with the Digital Visual Interface (DVI) protocol as described in the DVI 1.0 specification. The DVI 1.0 Specification is available from the Digital Display Working Group and is herein incorporated by reference in its entirety. It will be appreciated that the use of other digital display protocols is possible. Typically, communicating display information using such digital display protocols is done using cables that are not currently widely available. Additionally, such cables are also relatively expensive as compared to more conventional cables. Depending on the particular embodiment, such cables/interfaces may be compatible with both digital and analog video formats, as is indicated in the DVI 1.0 specification, as well as other specifications and standards directed to graphics interfaces with combined digital and analog video capabilities. For example, for embodiments implementing a DVI interface, an M1-D (M1 Digital) or M1-DA (M1 Digital/Analog) cable and connectors may be used to communicate graphics information from a graphics source (e.g., a computer) to the display device. For graphics interfaces employing an M1-DA connector, such interfaces may also receive analog video data (e.g., RGB video data) via the M1-DA connector.

In other applications, it may be desirable to have graphics display information “loop-through” the display device (e.g., a display projector) to a second display device. Employing such a technique in a display projector, display information is communicated to the projector, such as from a desktop computer, for display on a wall or screen. The display information is also looped-through the projector to a graphics output port for communication to a second display device, such as a computer monitor, flat panel display, etc. In certain embodiments, the graphics output port will include a Video Electronics Standards Association (VESA) connector, which is compatible with widely available, relatively inexpensive cables. In such a configuration, the display information may be communicated to the projector using an M1-D/A cable/connector, a VESA cable/connector, or any other appropriate cable and connector interface or wireless interface. The display (graphics) information in such embodiments may be communicated using any number of analog video standards, such as those available from the Video Electronics Standards Association, 920 Hillview Ct., Suite 140, Milpitas, Calif. 95035.

In still other applications it may be desirable that a display device (e.g., a display projector) have a first graphics input port that is capable of receiving graphics information via an M1-D or M1-DA cable/connector (or the like) and a second graphics port for receiving graphics information via an alternative cable/connector (e.g., a VESA cable/connector configuration). Such a technique may be desirable when the first graphics input port of the display device is being utilized, for example, by a wireless module that is difficult to remove (such as in the case of a ceiling mounted projector) and an entity that is providing graphics information to the display device does not have wireless capability. Alternatively, for embodiments implementing the first graphics input port using an M1 connector, a cable compatible with such M1 connectors may not be readily available to establish communication between the entity providing graphics information (e.g., a desktop computer) and the display device (e.g., a projector). Therefore, the availability of the second input graphics port may provide a more conventional alternative for communicating graphics information to the display device.

2. Current Display Devices

Referring now to FIG. 1, a prior display device 100 that implements a graphics input port and a loop-through graphics output port is shown. The display device is employed to produce the display 105. The display 105 may be a still image or a moving image. In this particular embodiment, the graphics input port includes a first VESA connector 110. Likewise, the graphics output port includes a second VESA connector 115.

As shown in FIG. 1, the first VESA connector 110 is coupled with a desktop computer 120. The computer 120 is further coupled with input devices 125 and 130, a keyboard and mouse, respectively. The second VESA connector 115 is coupled with a computer monitor 135.

For the configuration shown in FIG. 1, graphics information is communicated from the computer 120 to the projector 100 via the VESA connector 110. The graphics information is then used by the projector 100 (using video signal processing) to generate the display 105. The graphics information is looped-through the projector 100 and communicated (via the VESA connector 115) for display on the monitor 135. As may be seen in FIG. 1, the information contained in the display 105 and the information shown on the monitor 135 is the same.

Such a configuration is commonly used in educational and government applications where it is desirable to connect a desktop computer (such as the computer 120) to the projector 100 but also to provide a loop-through connection so that a presenter may view the material being displayed by the projector 100 using a monitor in close proximity to the computer 120, the keyboard 125 and the mouse 130. This configuration would be particularly useful in, for example, a classroom setting where the speaker's back may be to the display 105 while presenting a lecture. While using a laptop computer with a built in display in place of the computer 120 may be an alternative to such a configuration, educational and government institutions often do not purchase laptop computers due to the additional cost and ease of theft of such systems, as compared to desktop computer systems. Thus, the availability of loop-through functionality is highly desirable for such applications. However, in view of the desire for increased flexibility of use, the projector 100 does not, for example, provide for the ability to communicate graphics information using digital video protocols, such as defined in the DVI 1.0 protocol.

Referring now to FIG. 2, another previous display device (a projector 200) that implements a single graphics input port is shown. In similar fashion as the projector 100, the projector 200 produces the display 205. The graphics input port of the projector 200 is implemented using an M1-D/A connector 210. As was noted above, such a graphics input port may be used to receive digital video graphics information (such as in accordance with the DVI 1.0 protocol) or may be used to receive analog video graphics information. It will be appreciated that the projector 200 typically processes digital video graphics information and analog video graphics information in different fashions. For example, digital video graphics information would be translated from the protocol used to communicate with the projector 200 to a format for display by the projector, with the translation performed using digital processing. In contrast, analog video graphics information, which is typically communicated to the projector 200 using three channels, red, green and blue (RGB), and two synchronization signals, horizontal sync (H-Sync) and vertical sync (V-Sync), is converted for display with the projector 200 using, for example, an analog to digital converter. Of course, other formats of analog video are possible, such as those associated with television display devices, for example.

The graphics input port is coupled (via the M1-DA connector 210) with a wireless interface device 215. The wireless interface may be a radio-frequency (RF) interface, such as an interface in accordance with any of the IEEE 802.11 (wireless Ethernet) or IEEE 802.15 (Bluetooth) protocols. Of course, other wireless interfaces are possible, which may include RF interface protocols, infrared interface protocols, or any other suitable technique. Alternatively, a cable including an M1-DA connector that is compatible with the M1-DA connector 210 may be used to communicate graphics information to the projector 200.

For the configuration shown in FIG. 2, a laptop computer 220 communicates graphics information with the projector 200 via an air interface 225 (e.g., a radio interface) and the wireless interface device 215. Such a configuration is commonly used in corporate business settings, where the use of laptop computers with wireless capability is prevalent. However, due to the fact that the projector 200 includes only a single graphics input port, such a projector does not support loop-through of the graphics information from the computer 220. Furthermore, the configuration shown in FIG. 2 does not provide for use of the projector 200 with a computer that does not have wireless capability and appropriate software for communicating graphics information of the air interface 225. Thus, in order to employ the projector 200 in such a situation, the wireless interface 215 would be disconnected and a cable would be used to communicate graphics information to the projector 200. This approach may be inconvenient, however, as the projector 200, in certain applications, may be relatively inaccessible, such as when mounted on a ceiling or contained in a secured room or compartment for theft prevention. In other situations, an appropriate cable that is compatible with the M1-DA connector 210 may not be available to connect a graphics source (e.g., a laptop computer) with the projector.

It is desirable to implement a display device that provides for each of the above implementation configurations. However, using current techniques, such a display device would include three display ports and, thus, three connectors with supporting circuitry. Such a device would include a first graphics input port implemented using, for example, an M1-DA connector; a second graphics input port implemented using a more conventional connector, such as a VESA connector; and a graphics output port for loop-through graphics information, which may also be implemented using a VESA connector. Given the competing desire to reduce the size and mass of display devices, such a configuration may be commercially impracticable or even physically impossible in some display devices depending on the particular physical configuration. Therefore, alternative approaches for implementing a graphics interface that supports a wide variety of configurations for receiving and looping-through graphics information are desirable.

### BRIEF DESCRIPTION OF THE DRAWINGS

Exemplary embodiments are described herein with reference to the drawings, in which:

FIG. 1 is a drawing illustrating a first prior art display device including a first graphics interface;

FIG. 2 is a drawing illustrating a second art prior display device including a second graphics interface;

FIG. 3 is a drawing illustrating a display device including an improved graphics interface employed in a first configuration;

FIG. 4 is drawing illustrating the display device of FIG. 3 employed in a second configuration;

FIG. 5 is drawings illustrating VESA connectors (female and male) that may be employed in/with the graphics interface of the display device illustrated in FIGS. 3 and 4;

FIG. 6 is drawings illustrating M1-DA connectors (female and male) that may be employed in/with the graphics interface of the display device illustrated in FIGS. 3 and 4;

FIG. 7 is a block diagram illustrating a single graphics interface channel (e.g., red, green or blue) of the graphics interface that may be employed in the display device illustrated in FIGS. 3 and 4;

FIG. 8 is a block diagram illustrating a single graphics sync channel (e.g., horizontal or vertical) of the graphics interface that may be employed in the display device illustrated in FIGS. 3 and 4; and

FIG. 9 is a schematic diagram illustrating a single graphics channel of the graphics interface that may be employed in the display device illustrated in FIGS. 3 and 4.

### DETAILED DESCRIPTION

While embodiments of graphics interfaces and embodiments of components of such interfaces are generally discussed herein with respect to projection display devices, it will be appreciated that the invention is not limited in these respects and that embodiments of the invention may be implemented in any number of different types of display devices. Further, as in most consumer/business electronics applications, it will also be appreciated that many of the elements of the various embodiments described herein are functional entities that may be implemented as hardware, firmware and/or software, and as discrete components or in conjunction with other components, in any suitable combination and location. Also, it will be appreciated that the drawings are for purposes of illustration and the elements shown in the drawings are not necessarily to scale.

1. Display Device with Improved Graphics Interface

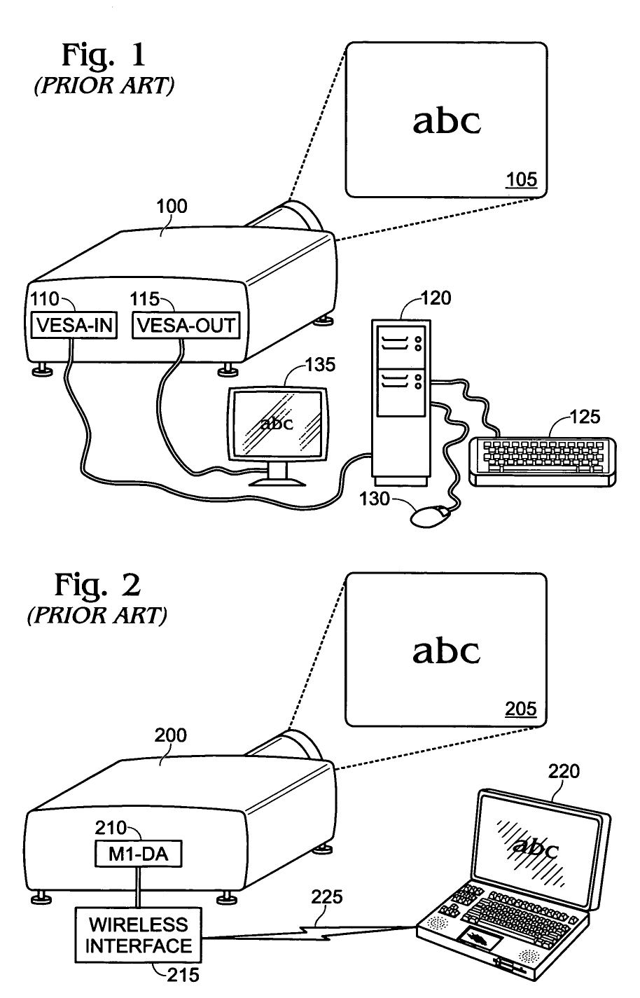

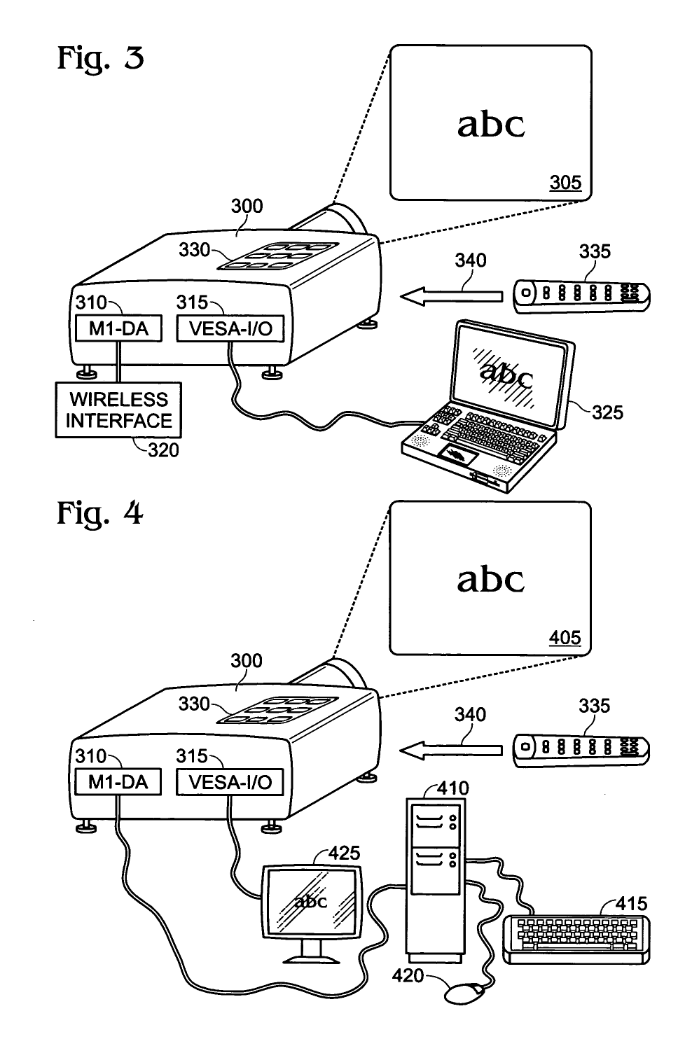

Referring now to FIG. 3, a display device (a projector 300) that provides additional flexibility for displaying graphics information as compared to the projectors 100 and 200 of FIGS. 1 and 2 (which are described above) is shown. In similar fashion with the projectors 100 and 200, the projector 300 is used to produce the display 305. The projector 300 includes an optical subsystem (e.g., one or more lenses, a lamp, one or more mirror devices, and a light tunnel) for displaying graphics information. Any number of possible optical sub-systems may be used. Such optical sub-systems are known and will not be discussed in detail here. The projector 300 includes a graphics interface with two graphics ports. The first graphics port operates as a graphics input port and is implemented using an M1-DA connector 310, which may receive either digital graphics information or analog graphics information. However, it will be appreciated that the first graphics port may be implemented using any number of other types of connectors, such as a DVI-Integrated connector.

The second graphics port operates as a selectable (manual and/or automatic) input/output graphics ports, which is implemented using a VESA connector 315. As may be seen in FIG. 3, the VESA connector 315 is designated VESA-I/O to indicate that the second graphics port may be selectively used as a graphics input port or a loop-through graphics output port. Of course, other connectors may be used in place of the VESA connector 315.

For the configuration shown in FIG. 3, the M1-DA connector of the first graphics port is coupled with a wireless interface device 320, which is analogous with the wireless interface device 215 of FIG. 2. The laptop computer 325 may not have wireless communication capability and/or may not have appropriate software installed to interface with the projector 300 via the wireless interface device 320, which may be an 802.11 or 802.15 wireless interface device, for example. Thus, as is shown in FIG. 3, the laptop computer 325 is coupled with the VESA connector 315. In this arrangement, the second graphics port would be selected to operate as a graphics input port. In such an arrangement, the projector 300 may be used to display graphics information from the laptop computer 325 without the need to disconnect the wireless interface device 320, which in certain applications, as described above, may be difficult or inconvenient due to the location of the projector 300 or the availability of an appropriate cable. In the event the projector 300 is inaccessible, an extension cable may be run to a convenient location for coupling the laptop computer 325 with the VESA connector 315.

The second graphics port may be selected to operate as a graphics input port in any number of ways. For example, the projector 300 may include service logic (e.g., implemented in hardware, software and/or firmware, or any other appropriate technique) that implements one or more set up menus. These menus may be displayed as display 305 (not specifically shown) and be navigated by a user to manually select the second graphics port as a graphics input port, for example. The menus may include a listing of various setup options for the graphics interface. For example, such a menu may include the following selections:
1) Digital video input on first graphics port, second graphics port disabled
2) Analog video input on first graphics port with video loop-through on second graphics port
3) Analog video input on second graphics port, first graphics port disabled

The user may use the keypad 330 included in the projector 300 to navigate such menus. Alternatively, the user may use a remote control 335 (e.g., an RF or infrared remote control) to navigate the menus. As shown in FIG. 3, the remote control 335 communicates with the projector 300 via an air interface 340. Still other possibilities for selecting the function of the second graphics port may exist. It will be appreciated that the menus discussed herein may be modified to include any number of options related to the function of the projector 300, such as picture quality options (e.g., brightness, resolution, contrast, etc.), as well as options related to the operation of the graphics interface of the projector 300.

Alternatively, the determination of whether the second graphics port should be configured as an input port or an output port may be accomplished automatically. The projector 300 may include service logic to detect the connection of a graphics input source (such as the laptop computer 325), or a display device (such as a computer monitor or flat panel display) with the second graphics port. Selection of the second graphics port as an input or output will be described in further detail below.

Referring now to FIG. 4, the projector 300 is shown in an alternative configuration where the projector 300 produces the display 405. In FIG. 4, like elements from FIG. 3 are referenced using the same reference numerals. These elements are only discussed with respect to FIG. 4 as needed to understand the arrangement illustrated in that drawing.

The M1-DA connector 310, for this configuration, is coupled with the desktop computer 410, which communicates graphics information to the projector 300. In like fashion with the computer 120 in FIG. 1, the computer 410 is coupled with a keyboard 415 and a mouse 420. The VESA connector 315 in FIG. 4 is coupled with a monitor 425 to display the graphics information communicated to, and looped through the projector 300. In such a configuration, the second graphics port would be configured as an output graphics port using, for example, the techniques described above (e.g., menus navigable with the keypad 330 or the remote control 335, or automatic selection using service logic to detect that the monitor 425 is coupled with the second graphics port via the VESA connector 425).

2. Graphics Port Connectors

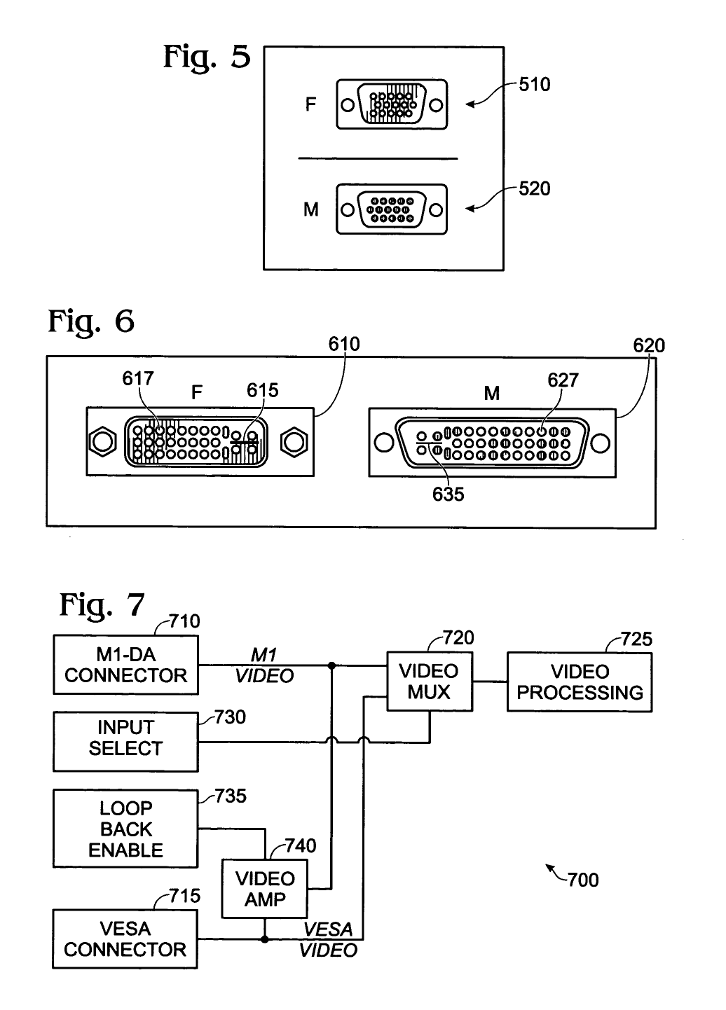

Referring to FIGS. 5 and 6, connectors that may be employed with the projector 300, or any other display device including a graphics interface such as the interface discussed with respect to the projector 300 are shown. FIG. 5 includes a drawing of a female VESA connector 510, which would typically be included in the projector 300 as VESA connector 315. FIG. 5 also includes a drawing of a male VESA connector 520, which would typically be included in a cable used, for the embodiments illustrated in FIGS. 3 and 4, to couple the laptop computer 325 (FIG. 3) or the monitor 425 (FIG. 4) with the second graphics port of the projector 300.

Referring now to FIG. 6, M1-DA connectors that may be employed with the projector 300 are shown. FIG. 6 includes a photo of a female M1-DA connector 610 that may be included as part of the first graphics port in the projector 300. The female connector 610 includes a first portion 615 for receiving digital video data and a second portion 617 for receiving analog video data. FIG. 6 also includes a photo of a male M1-DA connector 620 that may be included in a cable that may be used to couple, for example, the wireless interface device 320 or the computer 410 with the first graphics port of the projector 300. The male connector 620 includes a first portion 625 that is compatible with the first portion 615 of the female connector 610 and a second portion 627 that is compatible with the second portion 617 of the female connector 610. It will be appreciated that other connectors besides VESA and M1-DA connectors may be employed with display devices that include a graphics interface.

3. Selectable Graphics Port

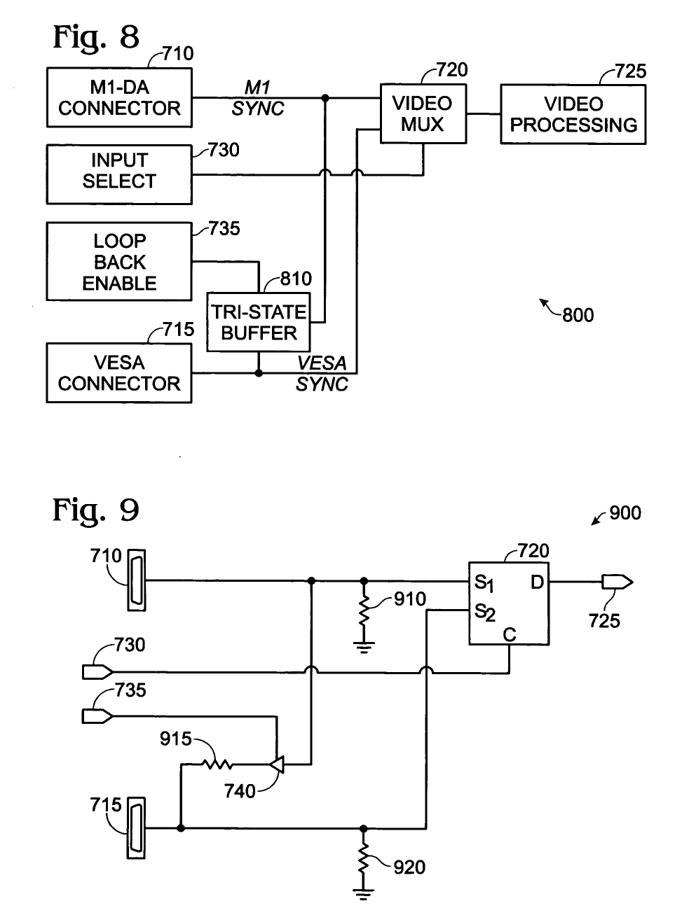

Referring now to FIG. 7, a block diagram illustrating a graphics interface channel 700 of a graphics interface that includes a graphics port that may be selectively configured as an input graphics port channel or a loop-through output graphics port channel is shown. It will be appreciated that for analog video, a graphics interface such as the graphics interface included in the projector 300 will include three substantially identical channels 700. The three channels will each be used, individually, to communicate one of the three components of analog video graphics information, red green and blue (RGB). It will be appreciated that the channel 700 (and the sync channel 800 shown in FIG. 8) are for use with analog video. As was noted above, digital video processing is handled in a different manner than analog video and, thus, may employ additional components or devices that are not shown or described in this disclosure.

The graphics interface channel 700 includes an M1-DA connector 710 and a VESA connector 715. It will be appreciated that the M1-DA connector 710 and the VESA connector 715 are used to communicate graphics information for all three channels of RGB analog graphics information, as well as the associated sync information. The M1-DA connector 710 and the VESA connector 715 are coupled with a video mux 720 that is used to multiplex between the M1-DA connector 710 and the VESA connector 715 for communicating RGB graphics information to a video processing unit 725. Video processing of RGB graphics information is known and will not be discussed in detail here for the sake of brevity.

The graphics port channel 700 further includes an input select signal source 730 (hereafter “input select signal 730”) and a loop-back enable signal source 735 (hereafter “loop-back enable signal 735”), which are both used for all three channels of RGB graphics information, as well as the associated sync information. The input select signal 730 and the loop-back enable signal 735 may be generated in any number of ways. For example, the signals may be generated as a result of selections made by a user, such as when navigating setup menus of a projector, as described above. Alternatively, the input select signal 730 and the loop-back enable signal 735 may be generated automatically by service logic included in a display device in which the graphics interface channel 700 is implemented.

For example, if the display device determines that a monitor is coupled with the VESA connector 715 and an analog graphics information source (e.g., a computer) is coupled with the M1-DA connector 710, the input select signal 730 would be set such that the video mux 720 communicates video signals from the M1-DA connector 710 to the video processing unit 725. Also, in this situation, the loop-back enable signal 735 would be set such that a video amp 740 is enabled. Enabling the video amp 740 provides for the analog graphics information received by the M1-DA connecter 710 being looped-back through the display device and communicated to the monitor that is coupled with the VESA connector 715.

Alternatively, for example, a user may navigate one or more setup menus that are implemented by a display device including the graphics interface channel 700 using the techniques described above, or any other appropriate technique. When navigating these menus, the user may indicate that it is desired to use the VESA connector 715 as a graphics input port. In this situation, the display device (e.g., the projector 300) may include service logic (which, as noted above, may be implemented using hardware, firmware, software or any other appropriate technique) that sets the input select signal 730 such that the video mux 720 communicates video signals from the VESA connector 715 to the video processing unit 725. Also, in this situation, the loop-back enable signal 735 would be set such that the video amp 740 is disabled, as loop-back is not desired in this configuration. Of course, other approaches for configuring the graphics interface channel 700 (and associated channels) are possible.

3. Selectable Graphics Port Sync Channels

Referring now to FIG. 8, a block diagram illustrating a sync signal channel 800 of a graphics interface that includes a port that may be selectively configured for use as an input sync port or a loop-through sync port is shown. It will be appreciated that for analog video, a graphics interface such as the graphics interface included in the projector 300 will include two substantially identical sync channels 800. The two channels will each be used, individually, to communicate one of the two analog video sync signals, horizontal sync (H-sync) and vertical sync (V-sync) to the video processing unit 725 (via the video mux 720). The H-sync and V-sync signals are used in conjunction with the RGB graphics information communicated using the graphics interface channels 700. In FIG. 8, like elements with FIG. 7 are referenced with the same reference numbers as in FIG. 7.

Because the sync channels operate in conjunction with the RGB graphics information, selection of the signals to be communicated to the video processing unit 725 by the video mux 720 is accomplished in the same fashion as selection of the RGB signals (from the M1-DA connector 710 or the VESA connector 715) to be communicated to the video processing unit 725. Therefore, such selection is not described in detail here. Similarly, loop-back of the sync signals is accomplished in a similar fashion as loop-back of the RGB signals and, thus, also is not described in detail here. It is noted, however, that the sync channel 800 includes a tri-state buffer 810, which is enabled/disabled by the loop-back enable signal 735, as opposed to the video amp 740 used for the RGB signals.

4. Selectable Graphics Port Channel

Referring now to FIG. 9, a more detailed schematic of an embodiment of a selectable graphics interface channel 900 is shown for use in an embodiment employing a 75 ohm cable for communicating graphics information via the M1-DA connector 710. The channel 900 is substantially similar to the channel 700 illustrated in FIG. 7. Therefore, the details of the channel 700 discussed above with respect to FIG. 7 will not be repeated here. In FIG. 9, like elements with FIG. 7 are referenced with the same reference numbers as FIG. 7. It is noted that the channel 900 additionally includes a ground termination resistor 910 that reduces the amount of signal reflections for the RGB signals received via the M1-DA connector 710. The channel 900 further includes a back-termination resistor 915, which reduces signal reflections and reduces (to an appropriate level) the voltage of the signals communicated to a display device (such as the monitor 425 in FIG. 4) via the VESA connector 715. The channel 900 also includes a ground second termination resistor 920, which reduces reflections of RGB signals received via the VESA connector 715. Again, it is noted that any number of alternative connector configurations may be used to implement such graphics interface channels and sync channels (and display devices including such channels).

5. Conclusion

Various arrangements and embodiments in accordance with the present invention have been described herein. These embodiments provide an improved graphics interface for use in a display device that allows for multiple configurations using two connectors and associated circuitry, where using prior techniques three connectors and associated circuitry would be employed. Therefore, such embodiments improve the flexibility of use of such display devices while still allowing for greater potential reductions in physical size and mass of such display devices, as compared to a device with three connectors. It will be appreciated, however, that those skilled in the art will understand that changes and modifications may be made to these arrangements and embodiments without departing from the true scope and spirit of the present invention, which is defined by the following claims.

What is claimed is:

1. A graphics interface included in a first graphics display device, the graphics interface comprising:
a first graphics port that, in operation, functions as a graphics input port receiving graphics information to be displayed by the first display device from a graphics source; and
a second graphics port that selectively operates as one of an alternative graphics input port to the first graphics port and a graphics output port,
wherein the second graphics port, when operating as a graphics output port, communicates the graphics information received at the first graphics port to a second graphics display device.

2. The graphics interface of claim 1, wherein when the second graphics port is operating as an alternative graphics input port the first graphics port is disabled.

3. The graphics interface of claim 1, wherein the first graphics port, in operation, receives one of digital graphics information and analog graphics information.

4. The graphics interface of claim 3, wherein when the first graphics port receives digital graphics information the second graphics port is disabled.

5. The graphics interface of claim 3, wherein the analog graphics information is graphics information in accordance with a Video Electronics Standards Association analog video standard.

6. The graphics interface of claim 1, wherein the first and second graphics ports each includes a plurality of analog video channels.

7. The graphics interface of claim 6, wherein the plurality of analog video channels comprises:
a first channel used to communicate a red-component analog video signal;
a second channel used to communicate a green-component analog video signal;
a third channel used to communicate a blue-component analog video signal;
a fourth channel used to communicate a horizontal-synchronization signal; and
a fifth channel used to communicate a vertical-synchronization signal.

8. The graphics interface of claim 1, wherein the first graphics port includes an M1-DA compatible connector and the second graphics port includes a Video Electronics Standards Association compatible connector.

9. The graphics interface of claim 1, wherein the first display device is a projection display device.

10. The graphics interface of claim 1, wherein the second display device is one of a cathode-ray tube display device, a liquid-crystal display device and a plasma flat-panel display device.

11. A projection display system for displaying graphics information, the projection display system comprising:
an optical sub-system to display the graphics information on a display surface;
a graphics interface comprising:
a first graphics port that, in operation, functions as a graphics input port receiving to be displayed graphics information from a graphics source; and
a second graphics port that, in operation, selectively operates as one of an alternative graphics input port to the first graphics port and a graphics output port,
wherein the second graphics port, when operating as a graphics output port, communicates the graphics information received at the first graphics port to another display device, and
service logic for selecting whether the second graphics port operates as an alternative graphics input port or a graphics output port.

12. The projection display system of claim 11, wherein the service logic implements one or more menus for selecting whether the second graphics port operates as an alternative graphics input port or a graphics output port, the menus being user navigable and displayed by the projection display system.

13. The projection display system of claim 12, wherein the menus are navigable using a keypad included in the projection display system.

14. The projection display system of claim 12, wherein the menus are navigable using a remote control that is compatible with a receiver included in the projection display system.

15. The projection display system of claim 11, wherein the service logic provides for:
determining a type of device that is coupled with the second graphics port; and
selecting whether the second graphics port operates as an alternative graphics input port or a graphics output port based on the determination of the type of device.

16. The projection display system of claim 15, wherein, when it is determined that a graphics information source is coupled with the second graphics port, the service logic disables the first graphic port and selects the second graphics port as an alternative graphics input port.

17. The projection display system of claim 15, wherein, when it is determined that a display device is coupled with the second graphics port, the service logic selects the second graphics port as a graphics output port and enables a video amp to communicate the graphics information received at the first graphics port to the second graphics port, via the video amp, for display with the display device.

18. A graphics interface included in a display device comprising:
a video multiplexer;
a video amp;
a graphics input port coupled with the video multiplexer and the video amp;
a graphics input/output port coupled with the video multiplexer and the video amp;
an input select signal source coupled with the video multiplexer, wherein a signal produced by the input select signal source determines whether graphics information displayed by the display device is obtained from the graphics input port or the graphics input/output port;
a loop-back-enable signal source coupled with the video amp, wherein a signal produced by the loop-back-enable signal source determines whether the video amp is enabled to communicate graphics information from the graphics input port to the graphics input/output port.

19. The graphics interface of claim 18, wherein the graphics input port and the graphics input/output port each comprises:
a first channel used to communicate a red-component analog video signal;
a second channel used to communicate a green-component analog video signal;
a third channel used to communicate a blue-component analog video signal;
a fourth channel used to communicate a horizontal-synchronization signal; and
a fifth channel used to communicate a vertical-synchronization signal.

20. The graphics interface of claim 19, wherein the first second and third channels of each of the graphics input port and the graphics input/output port each further comprise at least one termination resistor to reduce reflections in the red-component, green-component and blue-component analog video signals.

21. The graphics interface of claim 19, wherein the first second and third channels of the graphics input/output port further each comprise a back-termination resistor coupled with the video amp and the graphics input/output port to reduce signal reflections and reduce voltage levels of graphics information signals communicated from the graphics input port to the graphics input/output port via the video amp.
